(19) United States
(12) Patent Application Publication
(10) Pub. No.: US 2007/0118594 A1
(43) Pub. Date: May 24, 2007

(54) Communication system

(75) Inventors: Nobuyuki Takeda, Hachioji-shi (JP); Shigeru Fukazawa, Hachioji-shi (JP); Yasumasa Sasaki, Tachikawa-shi (JP); Shinichi Kashimoto, Ome-shi (JP); Michiaki Eri, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/543,780

(22) Filed: Oct. 6, 2006

(30) Foreign Application Priority Data
Oct. 20, 2005 (JP) 2005-305864

(51) Int. Cl. G06F 15/16

(52) U.S. Cl. 709/203

(57) ABSTRACT

According to one embodiment, a communication system includes a plurality of communication terminals are connected to a communication network and a server apparatus which are connected to the communication network, the server apparatus includes a first renewing unit to renew the network configuration information in the second management table and a first transmitter which reads out the network configuration information stored in the second management table in response to an acquisition request for the network configuration information to transmit the corresponding network configuration information to a communication terminal of a request origin, and the plurality of the communication terminals include a second transmitter which transmits the acquisition request for the network configuration information to the server apparatus, and a second renewing unit to renew the network configuration information stored in the first management table based on the network configuration information in response to the transmission of the acquisition request.

### CROSS-REFERENCE TO RELATED APPLICATIONS

This application is based upon and claims the benefit of priority from Japanese Patent Application No. 2005-305864, filed Oct. 20, 2005, the entire contents of which are incorporated herein by reference.

### BACKGROUND

1. Field

One embodiment of the invention relates to a communication system for use in a visual communication system (VCS) or the like.

2. Description of the Related Art

In offices and business establishments, local area network (LAN) systems are used. Such LAN systems support, for instance, telephone sets in a telephone exchange such as a private branch exchange (PBX) and a key telephone apparatus as extension terminals and makes exchange connections among the extension terminals and an external communication network such as a public network and inter-extension terminal through the telephone exchange to enable a telephone call.

Recently, a system, for making a voice communication system using the telephone exchange cooperate with a data communication system using a server therein by connecting the system to the telephone exchange via the server with data terminals such as videophone terminals and personal computers connected thereto, has been presented (for example, Jpn. Pat. Appln. KOKAI Publication No. 8-321889).

Meanwhile, in the aforementioned parallel type system of the telephone exchange and server, it has been strongly desired for the VCS, in which data communication connections among data terminals cooperate with call states of telephone terminals to constitute a video conference, etc.

By the way, in the case of achievement of the VCS, the following measures need to be examined.

Namely, each data terminal needs to register beforehand network configuration information including terminal IDs of all the data terminals connected to the server. Then, at every change in a system such as a change in a numbering schedule or in an increase of the data terminals, each data terminal requires to acquire the network configuration information from the server to renew it. To acquire the network configuration information, a user has to manually input the information, or a manager of the server has to rewrite data by means of remote access or distribute setting files, and then the user has to read in it into the data terminal, so that it takes time and labor to renew the information.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view illustrating a communication system regarding a first embodiment of the present invention;

FIG. 2 is an exemplary view illustrating an example of network configuration information to be stored in a database illustrated in FIG. 1;

FIG. 3 is an exemplary block diagram illustrating a functional configuration of a maintenance server illustrated in FIG. 1;

FIG. 4 is an exemplary block diagram illustrating a functional configuration of a client terminal illustrated in FIG. 1;

FIG. 5 is an exemplary sequence view illustrating transmitting/receiving operations of information among the maintenance server, the database, an application server and the client terminal when acquiring the network configuration information at a time of log-on in the first embodiment;

FIG. 6 is an exemplary flowchart illustrating a control processing procedure of the maintenance server in renewing the network configuration information in the first embodiment;

FIG. 7 is an exemplary flowchart illustrating a control processing procedure of the client terminal at the time of log-on in the first embodiment;

FIG. 8 is an exemplary block diagram illustrating a functional configuration of a maintenance server regarding a second embodiment of the present invention;

FIG. 9 is an exemplary sequence view illustrating transmitting/receiving operations of information among a maintenance terminal, the maintenance server, a data base, an application server and a client terminal in renewing the network configuration information in the second embodiment;

FIG. 10 is an exemplary flowchart illustrating a control processing procedure of the maintenance server in renewing the network configuration information in the second embodiment; and

FIG. 11 is an exemplary flowchart illustrating a control processing procedure of the client terminal in the second embodiment.

### DETAILED DESCRIPTION

Various embodiments according to the invention will be described hereinafter with reference to the accompanying drawings, In general, according to one embodiment of the invention, a communication system, comprising a plurality of communication terminals which are connected to a communication network, assigned terminal IDs and communications based on a first management table with network configuration information including a plurality of terminal IDS stored therein; and a server apparatus which are connected to the communication network and executes communication control among the plurality of communication terminals based on a second management table with the network configuration information stored therein, wherein the server apparatus comprises: a first renewing unit to renew the network configuration information in the second management table when a renewal request for the network configuration information is issued; and a first transmitter which reads out the network configuration information stored in the second management table in response to an acquisition request for the network configuration information to transmit the corresponding network configuration information to a communication terminal of a request origin when the acquisition request for the network configuration information is transmitted from the communication terminal, and each of the plurality of the communication terminals comprises: a second transmitter which transmits the acquisition request for the network configuration information to the server apparatus when the fact that the network configuration information has been renewed is notified from the server apparatus; and a second renewing unit to renew the network configuration information stored in the first management table based on the network configuration information transmitted from the server apparatus in response to the transmission of the acquisition request.

### First Embodiment

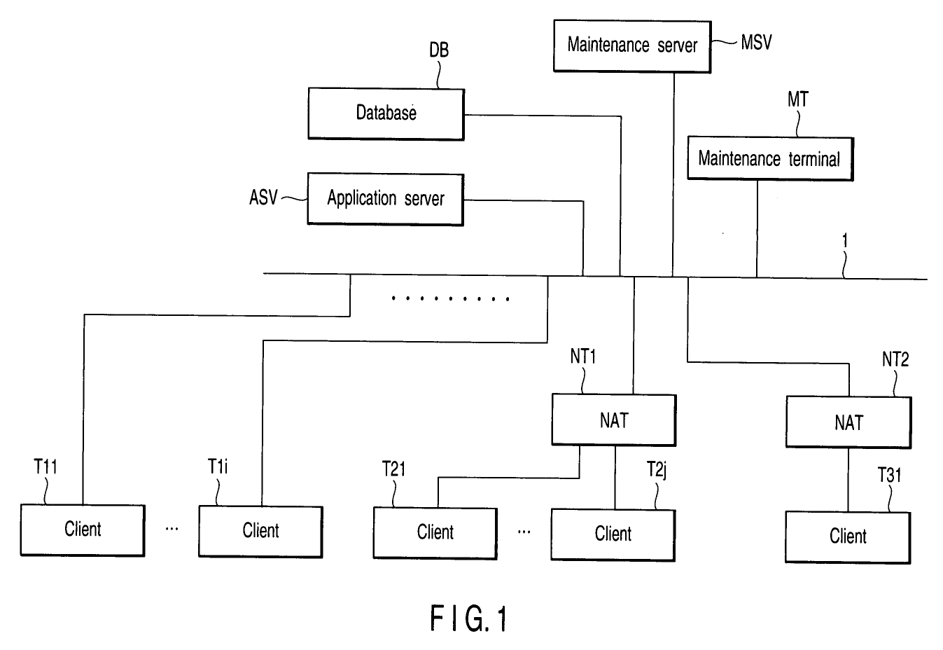

FIG. 1 is a schematic configuration view showing a communication system regarding a first embodiment of the present invention.

The system has a communication line 1 to transmit a video signal, computer data, etc. The communication line 1 connects a plurality of client terminals T11-T1i (i is natural number) and network address translator (NAT) routers NT1 and NT2 as communication terminals.

The plurality of the client terminals T11-T1i each use general-purpose personal computers. The NAT router NT1 is connected to a plurality of client terminals T21-T2j (j is natural number), and the NAT router NT2 is connected to a client terminal T31. The NAT routers NT1 and NT2 each have address conversion functions among the client terminals T21-T2j, T31 and communication line 1.

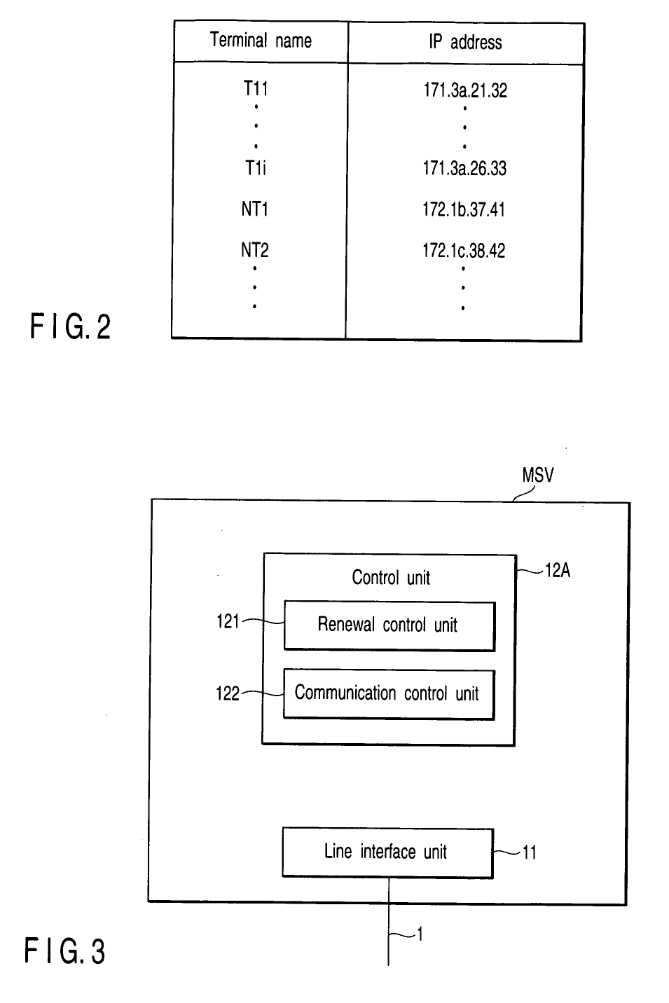

A maintenance server MSV, a database DB and an application server ASV are connected to the communication line 1. Out of them, the database DB stores, as shown in FIG. 2, network configuration information showing corresponding relationships among names of the client terminals T11-T1i and of the NAT routers NT1 and NT2 as router IDs and global IP addresses as terminal IDs assigned to the client terminals T11-T1i and NAT routers NT1 and NT2, respectively, and as network IDs.

The application server ASV has a conversion control function for the plurality of client terminals T11-T1i and NAT routers NT1 and NT2 based on the network configuration information to be stored in the database DB.

The maintenance server MSV manages connection situations of the plurality of client terminals T11-T1i and NAT routers NT1 and NT2 on the communication line 1.

FIG. 3 is a block diagram showing a functional configuration of the maintenance server MSV.

The maintenance server MSV has a line interface unit 11 and a control unit 12A. Out of them, the line interface unit 11 conducts interface processing to and from the communication line 1.

The control unit 12A has a renewal control unit 121 and a communication control unit 122 as new functions in regard to the present invention in addition to control functions regarding situation managements of the plurality of client terminals T11-T1i and NAT routers NT1 and NT2.

When a renewal instruction of the network configuration information is input from a maintenance terminal MT, the renewal control unit 121 conducts a renewal processing of the network configuration information stored in the database DB.

The communication control unit 122 makes communications among the plurality of client terminals T11-T1i, T21-T2j and T31 via the communication line 1, receives an acquisition request for the network configuration information transmitted from the plurality of client terminals T11-T1i, T21-T2j and the T31, and transmits the network configuration information stored in the database DB in response to the acquisition request.

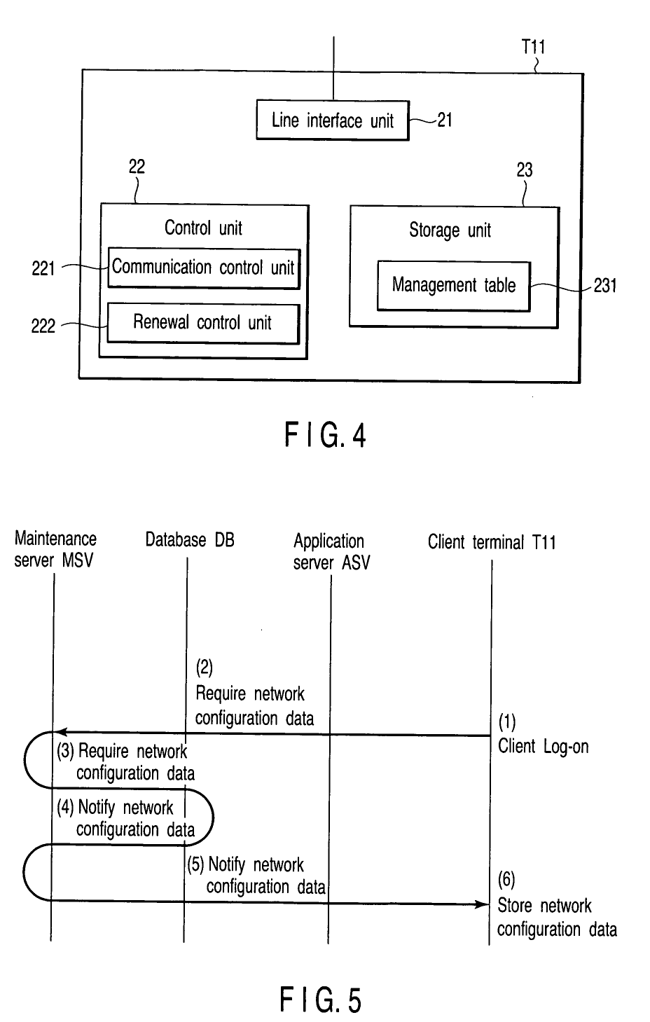

FIG. 4 is a block diagram showing functional configurations of the client terminals T11-T1i, T21-T2j and T31. Here, the client terminal T11 will be described as a representative of them.

The client terminal T11 is equipped with a line interface unit 21, a control unit 22 and a storage unit 23. The interface unit 21, among these units, performs an interface processing to and from the communication line 1.

The storage unit 23 is provided with a management table 231. The management table 231 stores the network configuration information to be stored in the database DB.

On the other hand, the control unit 22 has a communication control unit 221 and a renewal control unit 222 in addition to a control function to achieve an operation as a client terminal T11.

The communication control unit 221 effects communication among the application server ASV and the maintenance server MSV via the communication line 1, transmits an acquisition request for the network configuration information to the maintenance server MSV at the time of log-on, and also receives the network configuration information transmitted from the maintenance server MSV in response to the acquisition request.

The renewal control unit 222 renews the network configuration information stored in the management table 231, based on network configuration information transmitted from the maintenance server MSV.

Subsequently, operations of the communication system configured as mentioned above will be described.

FIG. 5 is a sequence view showing transmitting/receiving operations of information among the maintenance server MSV, database DB, application server ASV and client terminal T11 in acquiring the network configuration information at the time of log-on.

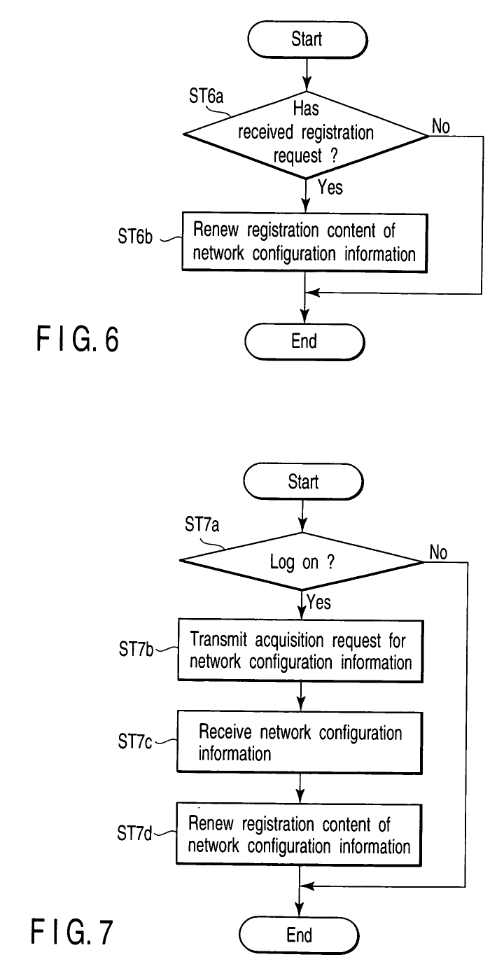

FIG. 6 is a flowchart showing a control processing procedure of the maintenance server MSV in renewing the network configuration information, and FIG. 7 is a flowchart showing a control processing procedure of the client terminal T11 at the time of log-on.

For instance, it is presumed that a manager of the maintenance terminal MT inputs a registration instruction at the maintenance terminal MT so as to add the NAT router NT2 and client terminal 31. The maintenance terminal MT then transmits a call request signal toward the maintenance server MSV to the communication line 1. When a communication link to and from the maintenance server MSV in response to the call request, the maintenance terminal MT transmits a registration request for the network configuration information to the maintenance server MSV via the communication link. The registration request includes the name and the global IP address of the NAT router NT2 desiring to be added.

In response to this, when receiving the registration request from the maintenance terminal MT in block ST6a, the maintenance server MSV sifts to block ST6b then adds the name and the global IP address of the NAT router NT2 into the network configuration information stored in the database DB. After completing the renewal processing, the maintenance server MSV shuts down the communication link. Further, the maintenance server MSV notifies the completion of the renewal of the network configuration information to the application server ASV.

On the other hand, when the client terminal T11 logs on in block ST7a [(1) in FIG. 5], it shifts to block ST7b then transmits the call request signal toward the maintenance server MSV to the communication line 1. When the communication link is established to and from the maintenance server MSV in response to the call request, the client terminal T11 transmits the acquisition request for the network configuration information to the maintenance server MSV via the communication link [(2) in FIG. 5].

Responding to this, when receiving the acquisition request from the client terminal T11, the maintenance server MSV reads the network configuration information from the database DB [(3), (4) in FIG. 5]. The maintenance server transmits the read network configuration information toward the client terminal T11 that is a request origin via the communication link under the establishment of the communication link [(5) in FIG. 5].

The client terminal T11 receives the network configuration information transmitted from the maintenance server MSV (block ST7c), and renews the contents of the network configuration information registered in the management table 231 based on the received network configuration information (block ST7d). Accordingly, the client terminal T11 can automatically renew the network configuration information at the time of log-on.

(Communication Among Client Terminals Under an Identical NAT Router)

Here, it is supposed that a communication is made between the client terminal T21 and the client terminal 22. The application server ASV then recognizes that the client terminals T21 and T22 work under the NAT routers NT1 based on the network configuration information in the database DB since the global IP addresses of the NAT router NT1 is added to communication packets notified from the client terminals T21 and T31 to notify the fact that it is under the NAT router NT1 to the client terminals T21 and T22. After this, the application server ASV makes both the client terminals T21 and T22 return the communication packets based on the global IP address of the NAT router NT1.

(Communication Among Client Terminals Under Different NAT Routers)

Here, it is assumed that communication is effected between the client terminals T21 and T31. The application server ASV then recognizes that the client terminals T21 and T31 belong to the NAT routers NT1 and NT2, respectively, based on the network configuration information in the database DB, and notifies the global IP address of the NAT router NT1 to the client terminal T31 as well as notifies the global IP address of the NAT router NT2 to the client terminal T21. After this, the application server ASV makes both the client terminals T21 and T31 return the communication packets based on these global IP addresses.

As mentioned above, in the first embodiment, the database DB registers the network configuration information beforehand, and when the renewal request for the network configuration information is issued due to the addition of the client terminal T31, etc., the maintenance server MSV renews the network configuration information in the database DB. After the completion of the renewal, the maintenance server MSV transmits the network configuration information in the database DB to the client terminals T11-T1i, T21-T2j and T31 that are the request origins in response to the acquisition requests for the network configuration information from each client terminal T11-T1i, T21-T2j and T31.

Accordingly, the users of each client terminal T11-T1i, T21-T2j and T31 become to register the network configuration information in the management table 231 only one time, thereby; renewal operations of the network configuration information can be extremely simplified. Further, since the acquisition requests for the network configuration information are automatically transmitted at the time of log-on thereof, the processing load of the maintenance server MSV may be reduced.

### Second Embodiment

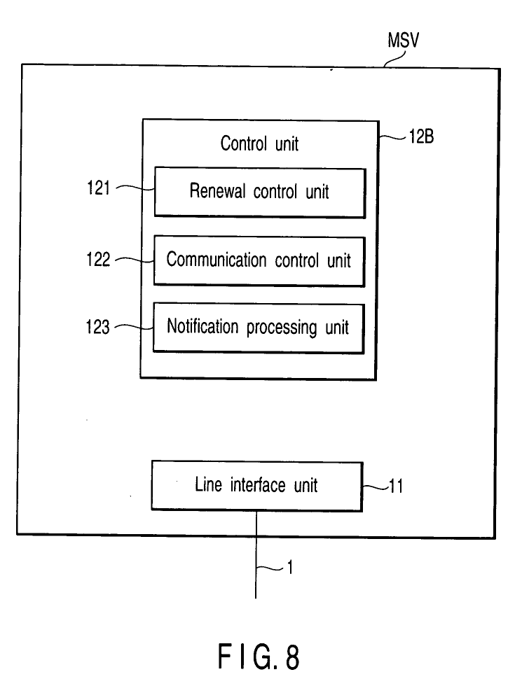

FIG. 8 is a block diagram showing a functional configuration of a maintenance server MSV regarding a second embodiment of the present invention. In FIG. 8, functions similar to those in FIG. 3 will be put similar reference marks and their detailed description will be omitted.

Namely, a control unit 12B further has a notification processing unit 123. The processing unit 123 determines whether or not the network configuration information stored in the database DB has been renewed, and in the case in which the network configuration information has been renewed, it notifies a massage showing the fact to each client terminal T11-T1i, T21-T2j and T31.

In concert with this, each client terminal T11-T1i, T21-T2j and T31 automatically transmits an acquisition request for the network configuration information, based on the renewal message.

Next, operations of the communication system configured as mentioned above will be account for.

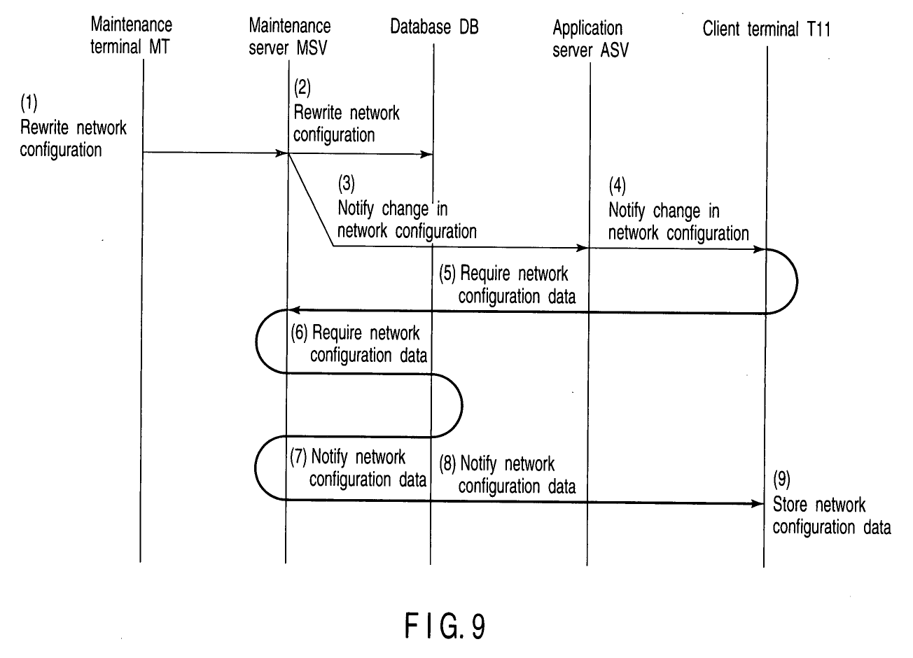

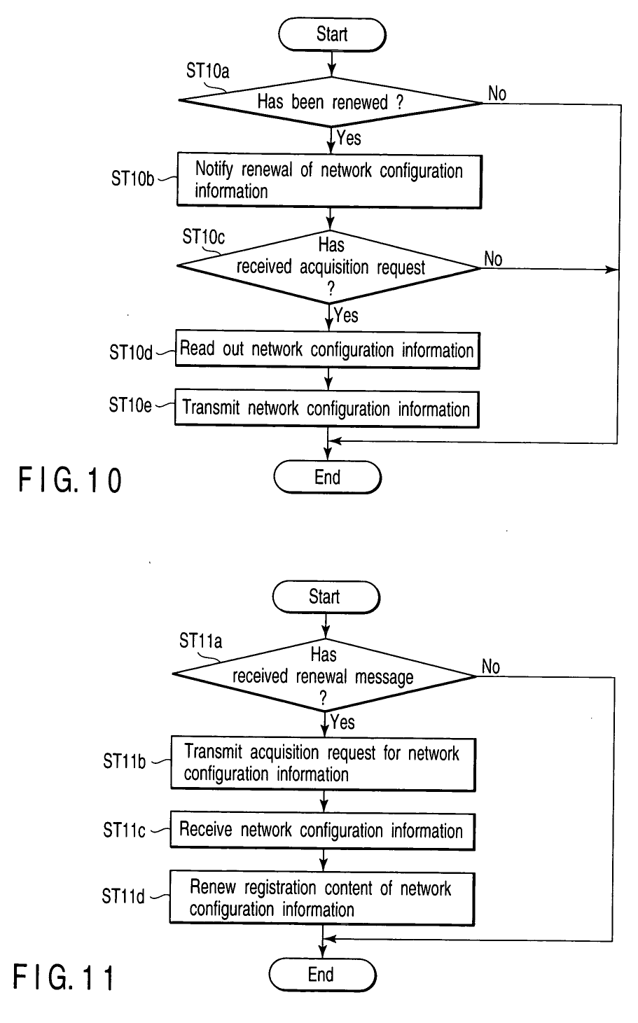

FIG. 9 is a sequence view showing transmitting/receiving operations of the information among the maintenance terminal MT, maintenance server MSV, database DB, application server ASV and client terminal T11 in renewing the network configuration information. FIG. 10 is a flowchart showing a control processing procedure of the maintenance server MSV in renewing the network configuration information, and FIG. 11 is a flowchart showing a control processing procedure of the client terminal T11.

For instance, it is presumed that the manager of the maintenance terminal MT inputs a registration instruction therethrough in order to add the NAT router NT2 and the client terminal T31. The maintenance terminal MT then transmits a call request signal toward the maintenance server MSV to the communication line 1. When a communication link to and from the maintenance server MSV is established in response to the call request, the maintenance terminal MT transmits a registration request for the network configuration information to the maintenance server MSV via the communication link [(1) in FIG. 9]. This registration request includes the name and the global IP address of the NAT router NT2 which is desired to be added.

In response to this, when receiving the registration request from the maintenance terminal MT, the maintenance server MSV adds the name and the global IP address of the NAT router NT2 into the network configuration information stored in the database DB [(2) in FIG. 9]. After completing the renewal processing, the maintenance server MSV then shuts down the communication link.

On the other hand, the maintenance server MSV monitors the registration state of the database DB in block ST10a, when the network configuration information is renewed, it moves to block ST10b to notify the fact that the network configuration information has been renewed to the application server ASV [(3) in FIG. 9].

The application server ASV notifies the fact that the network configuration information has been renewed to the client terminal T11 by using a keep alive signal among the application server and client terminals [(4) in FIG. 9].

In concert with this, when receiving the renewal message by means of the application server ASV in block ST11a, the client terminal T11 shifts to block ST11b then transmits a call request signal for the maintenance server MSV to the communication line 1. When a communication link to and from the maintenance server MSV is established in response to the call request, the client terminal T11 transmits the acquisition request for the network configuration information to the maintenance server MSV via the communication link [(5) in FIG. 9].

Responding to this, when receiving the acquisition request from the client terminal T11, the maintenance server MSV makes a shift from block ST10c to block ST10d then reads the network configuration information from the database DB [(6), (7) in FIG. 9]. The maintenance server MSV then transmits the read network configuration information toward the client terminal T11 that is the request origin via the communication link under the establishment [block ST10e, (8) in FIG. 9].

The client terminal T11 receives the network configuration information transmitted from the maintenance server MSV (block ST11c), then, based on the received network configuration information, it renews the contents of the network configuration information registered in the management table 231 (block ST11d).

As described above, in the second embodiment, when the network configuration information stored in the database DB is renewed though the maintenance server MSV, it notifies respectively the message about the fact of the renewal to the plurality of client terminals T11-T1i, T21-T2j and T31 connected to the communication line 1 to make them transmit the acquisition requests of the network configuration information.

Accordingly, the users of each client terminal T11-T1i, T21-T2j and T31 result in having to register the network configuration information in the management table 231 only one time, thereby; the renewal operation of the network configuration information can be extremely simplified, and also the updated data can always be acquired timely on the side of each client terminal T11-T1i, T21-T2j and T31 even when the network configuration is changed during the system operation.

### Other Embodiment

The present invention is not limited to the foregoing respective embodiments. For instance, in the first and second embodiments, examples, in which the NAT routers and client terminals are additionally registered in the network configuration information, have been described. However, the present invention is not limited to these examples; the network configuration information can be renewed similarly even when the NAT routers and client terminals are deleted. In this case, the communication system registers the NAT routers and client terminals in the same procedure as one in the case of additional registration. As for the renewal of the network configuration information other than the addition and deletion, the procedure is the same.

Having described about the examples of the respective embodiments in which the maintenance terminals renew the network configuration information, the communication system, for example, may renew the network configuration information by means of input units of a specific client terminal and a maintenance server.

In each of the embodiments, having described the cases in which the two parts that are the maintenance server and the application server share each processing, one server may achieve both functions of the maintenance server and the application server.

Further, various modifications can be put into effect without departing from the spirit or scope of the present invention with respect to the configurations and kinds of the communication system, the kinds and their configurations of the maintenance server and the client terminals, the control procedures and their contents of the maintenance server and client terminals in renewing the network configuration information, the contents of the network configuration information, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system, comprising a plurality of communication terminals which are connected to a communication network, assigned terminal IDs and communications based on a first management table with network configuration information including a plurality of terminal IDS stored therein; and
a server apparatus which are connected to the communication network and executes communication control among the plurality of communication terminals based on a second management table with the network configuration information stored therein,
wherein the server apparatus comprises:
a first renewing unit to renew the network configuration information in the second management table when a renewal request for the network configuration information is issued; and
a first transmitter which reads out the network configuration information stored in the second management table in response to an acquisition request for the network configuration information to transmit the corresponding network configuration information to a communication terminal of a request origin when the acquisition request for the network configuration information is transmitted from the communication terminal, and
each of the plurality of the communication terminals comprises:
a second transmitter which transmits the acquisition request for the network configuration information to the server apparatus when the fact that the network configuration information has been renewed is notified from the server apparatus; and
a second renewing unit to renew the network configuration information stored in the first management table based on the network configuration information transmitted from the server apparatus in response to the transmission of the acquisition request.

2. The communication system according to claim 1, wherein the first and the second management tables store network configuration information including router ID specifying a network address translator (NAT) router connected to the communication network and its network ID, when the plurality of the communication terminals consist of a plurality of first communication terminals connected to the communication network through an NAT router which converts the terminal ID into a network ID to make a communication via the communication network and a plurality of second communication terminals connected to the communication network without going through the NAT router.

3. The communication system according to claim 1, wherein the first renewing unit adds or deletes the corresponding terminal ID in the network configuration information, when a communication terminal is added to the communication network or deleted from the communication network.

4. A communication system, comprising a plurality of communication terminals, which are connected to a communication network, assigned terminal IDs and communications based on a first management table with network configuration information including a plurality of terminals IDs stored therein; and
a server apparatus which are connected to the communication network and executes communication control among the plurality of the communication terminals based on a second management table with the network configuration information stored therein,
wherein the server apparatus comprises:
a first renewing unit to renew the network configuration information stored in the second management table when a renewal request for the network configuration information is issued;
a notifying unit to notify the fact that the network configuration information has been changed to the plurality of the communication terminals in renewing the network configuration information by the first renewing unit; and
a first transmitter which reads out the network configuration information stored in the second management table in response to an acquisition request for the network configuration information to transmit the corresponding network configuration information to a communication terminal that is a request origin when the acquisition request for the network configuration information is transmitted from the communication terminal, and
each of the plurality of the communication terminals comprises:
a second transmitter which transmits the acquisition request for the network configuration information to the server apparatus when the fact is notified from the server apparatus; and
a second renewing unit to renew the network configuration information stored in the first management table based on the network configuration information transmitted from the server apparatus in response to the transmission of the acquisition request.

5. The communication system according to claim 4, wherein the first and the second management table store network configuration information including router ID specifying an NAT router connected to the communication network and its network ID, when the plurality of the communication terminals consist of a plurality of first communication terminals connected to the communication network through the NAT which converts the terminal ID into a network ID to make a communication via the communication network and a plurality of second communication terminals connected to the communication network without going through the NAT router.

6. The communication system according to claim 4, wherein the first renewing device adds or deletes the corresponding terminal ID in the network configuration information, when a communication terminal is added to the communication network or deleted to from the communication network.
